(19) United States
(12) Patent Application Publication
(10) Pub. No.: US 2015/0001840 A1
(43) Pub. Date: Jan. 1, 2015

(54) SECURITY DEVICE

(71) Applicant: Andrew Richard Parker, Surrey (GB)

(72) Inventor: Andrew Richard Parker, Surrey (GB)

(21) Appl. No.: 14/372,107

(22) PCT Filed: Jan. 11, 2013
(86) PCT No.: PCT/GB2013/050053

§ 371 Date: Jul. 14, 2014

(30) Foreign Application Priority Data
Jan. 13, 2012 (GB) 1200571.6

(51) Int. Cl. B42D 25/328

(52) U.S. Cl. CPC B42D 25/328
USPC 283/85

(57) ABSTRACT

A security device comprises a substrate having a region provided with an antireflective grating, and is configured to generate a security image when visible light is incident on the grating to provide authentication for an observer, wherein the grating comprises a combined broadband antireflective and narrowband reflective structure, the structure is antireflective for visible light between 400 and 700 nm which is incident within ±45° of a normal to the grating and the structure produces a narrowband reflection of light having a wavelength of less than 550 nm at glancing angles to the grating when visible light is incident at an angle greater than ±45° from the grating normal, wherein the security device is configured to generate the security image from the narrowband reflection.

The present invention relates to a security device. In particular it relates to a security device that comprises a combined broadband antireflective and narrowband reflective structure to generate a security image from visible light, for example, for use on a credit card or other article, in order to provide an anti-counterfeiting function, sometimes combined with an anti-glare or antireflective function.

Security devices come in many forms and are applied to an increasing number of products from credit and identity cards through to luxury items such as alcoholic beverages, tickets and media packages. Typically they comprise an optical device, such as a hologram, that generates a recognisable security image which would be difficult for a counterfeiter to replicate.

Antireflective coatings are also becoming more popular on a variety of devices such as watches and computer screens. These are sometimes formed by a two or, more usually, a three dimensional, profiled structure comprising an array of sub-micron sized protuberances. Visible light which is incident on the antireflective structure is reflected and/or refracted in such a way to prevent reflections from visible light being seen by the observer at most viewing angles. These coatings can therefore reduce the amount of glare from a watch or a computer screen. Due to the scale of the protuberances, which are nano-sized structures, the production of antireflective structures requires specialised machinery.

It is desired to provide a security device that generates a new form of security image that will be difficult for a counterfeiter to replicate and yet will be readily recognisable to an observer to provide authentication.

According to the present invention there is provided a security device comprising a substrate having a region provided with an antireflective grating, the security device being configured to generate a security image when visible light is incident on the grating to provide authentication for an observer, wherein the grating comprises a combined broadband antireflective and narrowband reflective structure, the structure being antireflective for visible light between 400 and 700 nm which is incident within ±45° of a normal to the grating and the structure producing a narrowband reflection of light having a wavelength of less than 550 nm at glancing angles to the grating when visible light is incident at an angle greater than ±45° from the grating normal, wherein the security device is configured to generate the security image from the narrowband reflection.

Preferably the security device is arranged to generate the security image from visible light that is reflected within the substrate at a glancing angle to the grating when the visible light is incident at an angle greater than ±45° from the grating normal, the narrowband reflection having a direction that is shallower than a critical angle for the light in the substrate, whereby it is guided along the substrate by total internal reflection. The glancing narrowband reflection is transmitted from a region of the substrate spaced from the grating where the angle of incidence is greater than the critical angle to generate the security image. An antireflective function for visible wavelengths above 550 nm will exist at all angles of incidence.

Preferably a narrowband violet or turquoise reflection is used to generate the security image, most preferably a narrowband violet reflection. A narrowband green reflection has also been observed in some orientations, particularly when a grating is illuminated from the opposite side and so may also be used to generate the security image.

In other preferred embodiments the security device is arranged to generate the security image from a narrowband reflection that is retro-reflected from a surface of the grating at a glancing angle to a plane of the grating on an incident side of the grating.

Preferably a narrowband violet, green, turquoise or UV-A reflection is used to generate the security image, most preferably a narrowband violet reflection.

Preferably the security device comprises a two dimensional grating. In other embodiments the security device may comprise a three dimensional grating.

Thus the security device comprises a combined broadband antireflective and narrowband reflective structure that is used to generate a security image, preferably one illuminated by a violet narrowband reflection. The security image is either generated from a narrowband violet (or green/turquoise) reflection guided by the substrate or it is generated by a narrowband violet, green, turquoise or ultraviolet-A that is retro-reflected at a glancing angle to the substrate. The violet or green/turquoise security image can provide authentication readily to an observer, for example to indicate that the article it is applied to is a genuine product or perhaps meets certain standards. In other embodiments the ultraviolet retro-reflection is used to generate a security image that can be read using a camera device. The creation of an antireflective grating having these properties is likely to be beyond the capabilities of most counterfeiters.

In one preferred arrangement, an antireflective grating is provided on a substrate comprising a layer of transparent material. The violet component of the light is retro-reflected within the transparent layer at a glancing angle. If the glancing angle is less than the critical angle for the transparent material, then total internal reflection will occur. As a result, the transparent layer can act as a light guide for the violet component. It is carried along within the transparent substrate until it reaches a surface where the angle of incidence is greater than the critical angle, such as an edge of the transparent layer, spaced from the antireflective structure. The transparent layer may be sandwiched between two opaque layers to provide greater contrast for the violet security image. These opaque layers may be printed or contain other features necessary for the function of the article. This arrangement has particular application for use in thin, laminated articles such as credit or identity cards, for example, where the violet light of the security image can be observed easily at an edge of the card whereby the card otherwise appears transparent. The opaque layers can be printed and provided with branding, raised card numbers and a magnetic strip, for example. Raised numbers could themselves form exit points for the violet light.

In another arrangement, the security device may comprise an antireflective grating that is provided on a region of an article and is arranged to generate the security image directly by retro-reflection. For example, a perimeter of the grating may be a specific shape distinct from that of the article to which it is applied. For example it may be in the shape of a code, character, symbol or mark, that is elongated in one dimension. In this way the grating may create an undistorted violet, green, turquoise or ultraviolet security image of the code, character, symbol or mark when it is viewed at a glancing angle in the elongated dimension that can be easily recognised by the observer or an optical reader to provide authentication.

Preferably the grating in this arrangement comprises a two-dimensional array of grooves and protuberances that is arranged to generate the security image only when viewed in that elongated dimension.

The security device can be stamped or moulded in a surface of an article, for example, the base of a vase, ornament or gemstone, etc., to indicate that the article is genuine or that it meets particular standards.

Thus the security image is generated by utilising a narrowband reflection (e.g. covering a wavelength range of less than 50 nm, more preferably 30 nm) and preferably consists of a visible violet (e.g., between 380-450 nm), green (e.g., between 490-550 nm), turquoise (e.g., between 470-520 nm) or UV-A (between 320-380 nm) reflection which is present at glancing angles to a plane of the grating. It is an image or optical effect that would not normally be seen by looking at an antireflective coating that has been applied for conventional purposes such as for reducing glare. The security image should have a distinctive form that is easily recognisable as a mark of authentication, e.g., it is a code, character, symbol, trade or certification mark, etc.

Certain preferred embodiments will now be described in greater detail by way of example only and with reference to the accompanying drawings, in which:

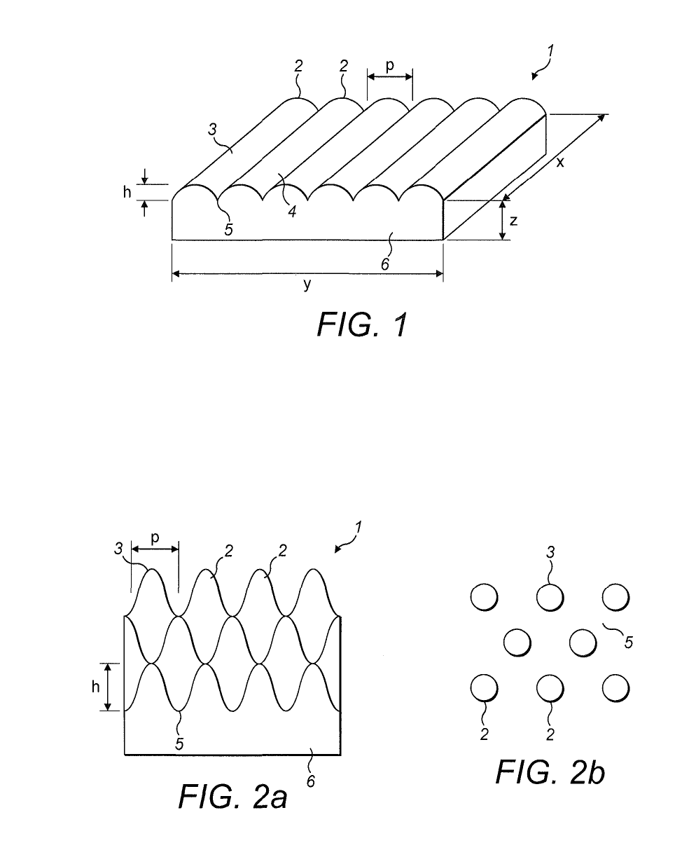

FIG. 1 is a perspective view of a two dimensional (2D) grating having a parallel array of grooves and protuberances;

FIG. 2a is a perspective view of a three dimensional (3D) grating having a hexagonal array of troughs and protuberances and FIG. 2b is a view of the grating of FIG. 2a from above;

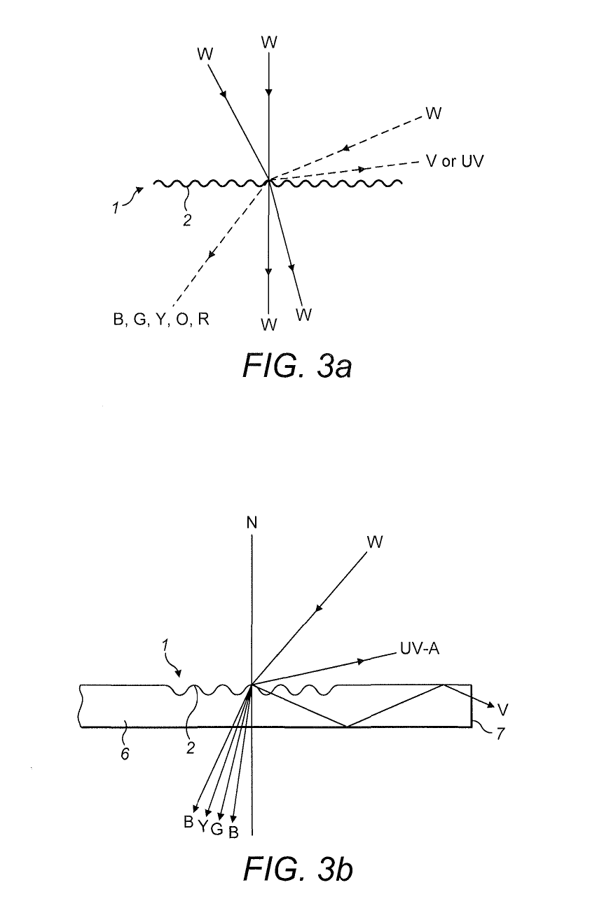

FIG. 3a is an illustration of the optical effect that gives rise to the violet and ultraviolet light at glancing angles at the surface of a substrate and FIG. 3b illustrates the optical effect in a transparent layer;

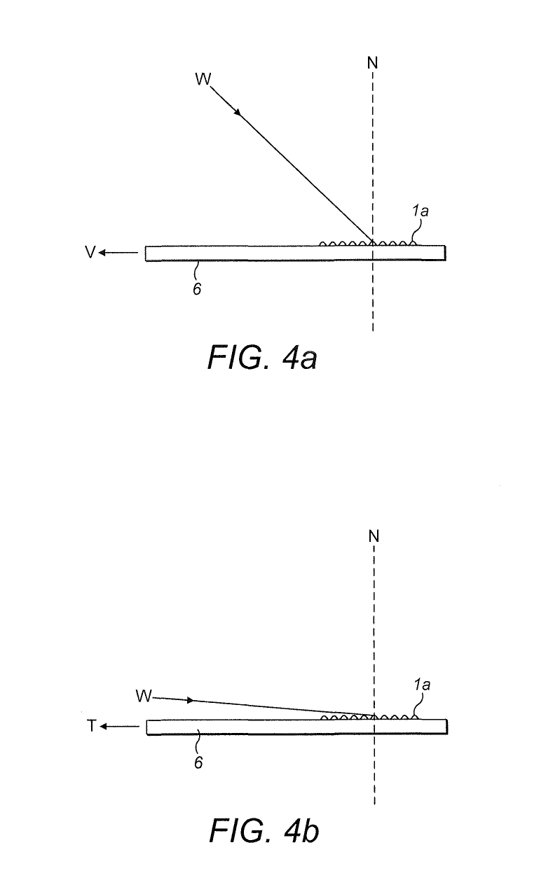

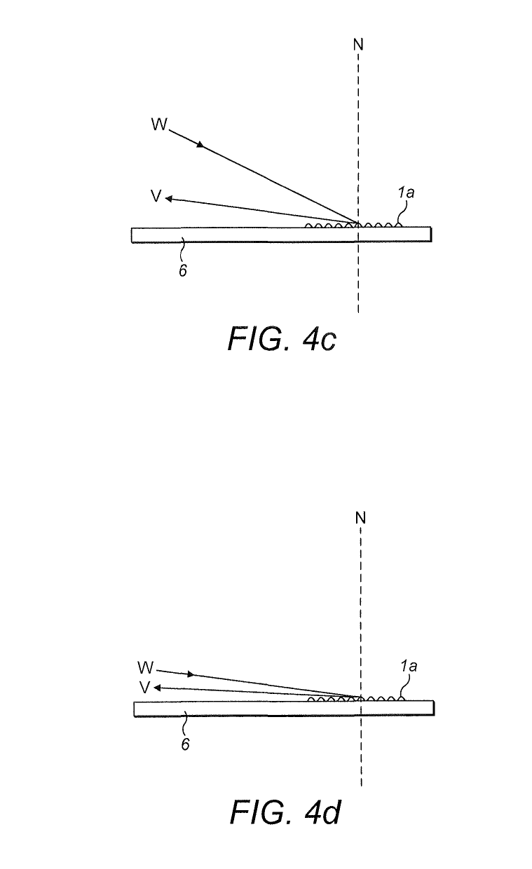

FIGS. 4a to 4d illustrate observed reflections in an example of a preferred antireflective grating;

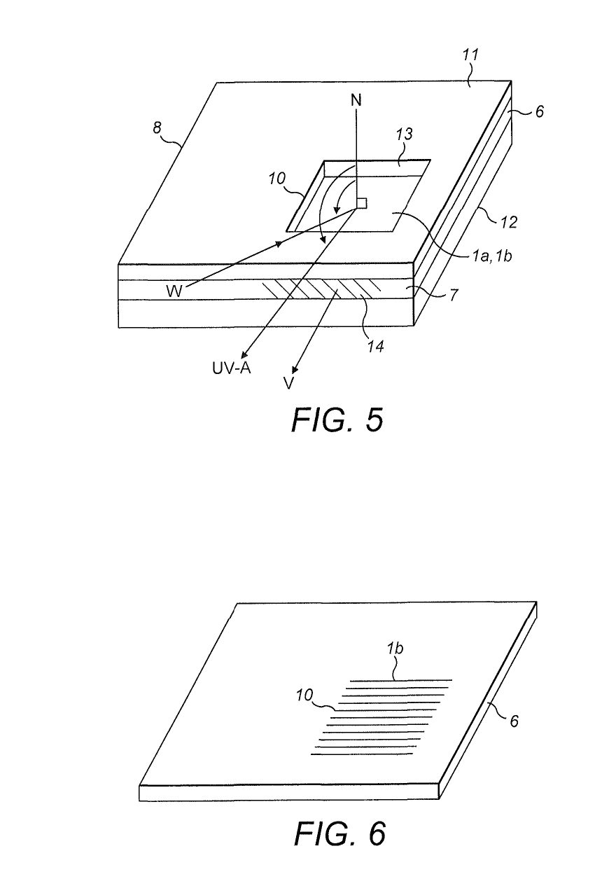

FIG. 5 is a perspective view of a credit card or identity card incorporating a preferred security device;

FIG. 6 is a perspective view of a middle layer for the credit card or identity card of FIG. 5;

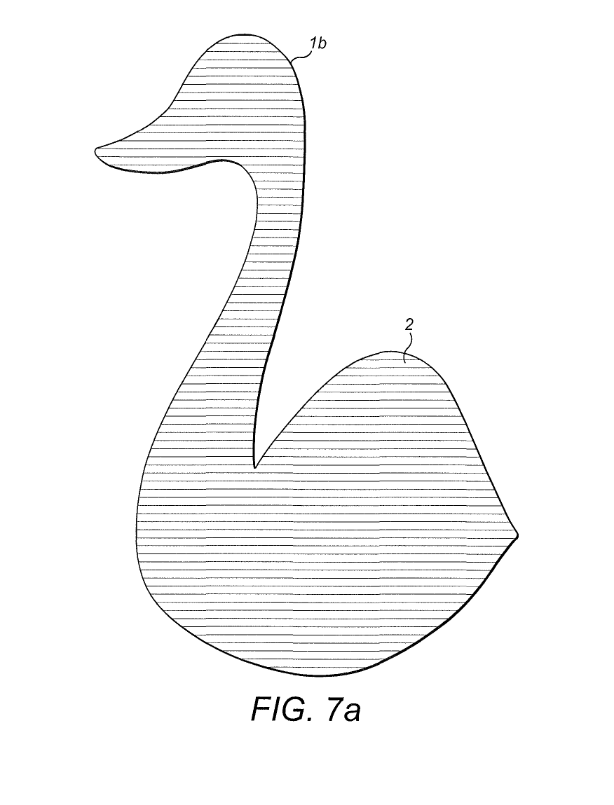

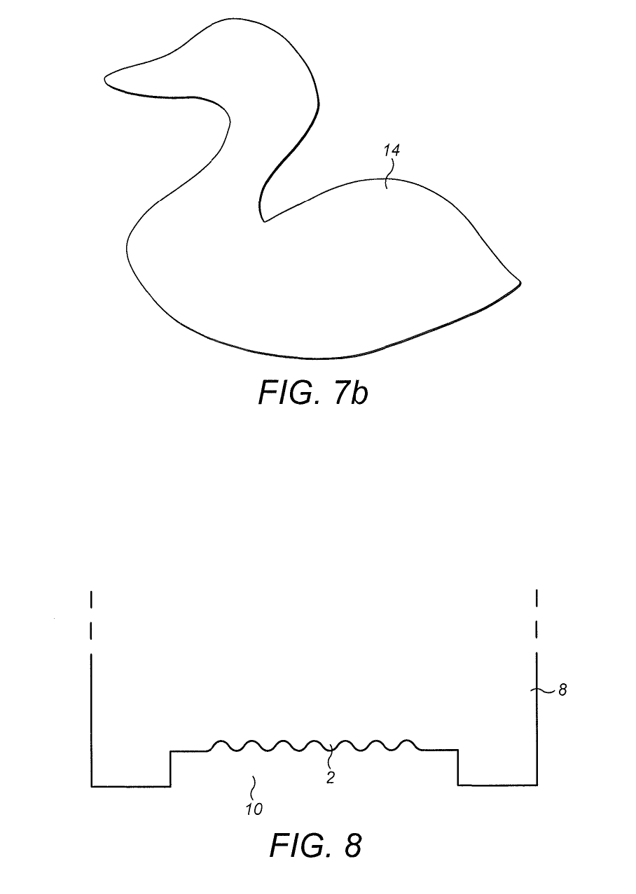

FIG. 7a is a view of a grating from above that is elongated in one direction and FIG. 7b is a view of the grating of FIG. 7a when viewed at a glancing angle;

FIG. 8 is a cross-sectional view illustrating a preferred security device provided to an inset of a base of an ornament;

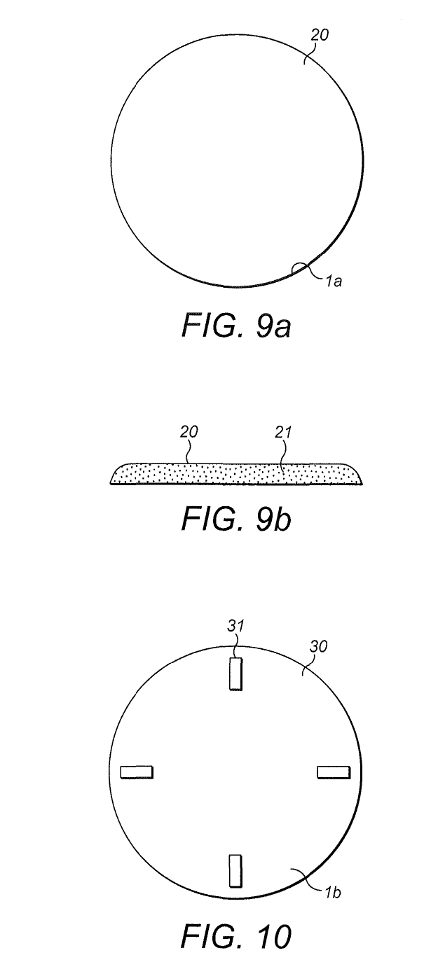

FIG. 9a is a plan view of a watch glass provided with an antireflective structure and FIG. 9b is a side view illustrating a violet colour visible at glancing angles; and

FIG. 10 is a plan view of a watch face provided with an antireflective structure.

Antireflective structures usually prevent light from leaving a surface by providing an arrangement of layers which generates reflections of light that are a quarter wavelength out of phase. These out-of-phase reflections cancel one another out so that the observer does not see the reflection. It occurs when light is incident on the structure from a first medium, e.g. air, is then partially reflected by the interface of a first layer of a greater refractive index, while a non-reflected component goes on to be partially or fully reflected by the interface with another layer having yet a higher refractive index, these reflections being separated by an optical distance equivalent to a quarter wavelength at the viewing angle. Antireflective structures can comprise a stack of such optical layers.

It is also known that gratings comprising a profiled surface formed from an array of protuberances can exhibit antireflective properties too. For a broadband antireflective structure that cancels out reflections in the visible spectrum, the protuberances are sub-micron in size, i.e., they have a dimension which is less than 1 μm in two or three dimensions depending on whether they are intended to provide a two or three dimensional grating.

An example of 2D grating 1a is illustrated in FIG. 1, where the sub-micron sized features extend as a parallel array of elongated grooves/protuberances 2, creating a set of parallel ridges and grooves. The grooves/protuberances 2 may have a more conical or a more rounded profile when viewed in cross-section than that shown. For example, the protuberances may be formed with substantially flat sides and pointed ridges and valleys, the protuberances may be formed with a roughly sinusoidal profile as illustrated schematically in FIG. 8 with rounded ridges and valleys, or the protuberances may be substantially hemispherical in cross-section as shown in FIG. 1, with rounded ridges having rounded peaks 3, rounded sides 4 and pointed valleys 5. Preferably the protuberances taper from their peak 3 to their valley 5 (not necessarily linearly) to provide a gradual increase in refractive index.

The profile of the grooves/protuberances 2 of the grating 1a in the security device may also vary across the region of substrate it covers, for example, to provide tonal contrast in the security image.

The grooves/protuberances 2 have the effect of modifying the refractive index of the substrate material to create a “layer” on the substrate that has a lower refractive index compared to the remainder of the substrate. The grating 1a, 1b will have a refractive index between that of the substrate material and the air (or other medium) which penetrates the grooves, depending on the profile of the protuberances/grooves 2, the volume ratios and some other factors. If the profile of the protuberances/grooves 2 is chosen appropriately, the refractive index can be modified to create a broadband antireflective structure where reflections of visible light (e.g., 400-700 nm) are substantially eliminated.

The height (h) of each protuberance 2 in the disclosure below is the distance from the peak of the ridge to the bottom of the valley 5 and preferably this value stays approximately constant across the antireflective structure, though it could vary. The periodicity (p) is the spacing between neighbouring peaks 3 or valleys 5, and again preferably this value remains approximately constant across the grating 1a though could vary according to the intended security image.

In another embodiment, the grating 1b comprises a 3D pattern, for example, a hexagonal array of troughs and protuberances 2 as shown in FIG. 2. These may have a conical profile with pointed peaks and valleys, a roughly sinusoidal profile as shown in FIG. 2 with rounded peaks 3 and valleys 5, or substantially hemispherical profiles with rounded peaks and pointed valleys similar to the 2D array illustrated in FIG. 1. Again preferably the protuberances are tapered (not necessarily linearly) so that they are narrower at their peak 3 and wider at the valleys 5 to provide a gradual change in refractive index.

The array need not be hexagonal but could be arranged in other geometrical forms or alternatively could comprise an irregular array of protuberances 2. The grating 1a, 1b of a security device may comprise a mixture of different forms of array of protuberances 2.

As shown in FIG. 2 the height (h) of each protuberance 2 in this arrangement is the distance from the peak 3 to the valley 5 and the periodicity (p) is the spacing between neighbouring peaks 3 or valleys 5.

Preferably the height (h) of the protuberances 2 for a two or a three dimensional array is less than 1.0 μm, for example, 0.5 μm or less. In some embodiments preferably the protuberances are less than 300 nm high, more preferably less than 200 nm high. The protuberances 2 may be, for example, between 100-180 nm high, and most preferably they are about 125 nm high (±25 nm). Taller protuberances could be advantageous in enhancing the relative intensity or perceived brightness of the security signal, although this may be at the expense of spectral purity.

Preferably the periodicity (p) of the protuberances for a two or three dimensional array is less than 0.5 μm, for example, between 100-300 nm. Preferably the protuberances have a periodicity of less than 275 nm, more preferably less than 250 nm. More preferably the protuberances have a periodicity of between 160-240 nm, and most preferably they have a periodicity of about 200 nm (±10 nm).

In certain preferred embodiments p is greater than h for the protuberances 2, and more preferably the ratio of p to h for the protuberances 2 is in the range of 1:1.5 to 1:2. More preferably the ratio of p to h for the protuberances is in the range of 1:1.6 to 1:1.9 (±0.05), and still more preferably it is around 1:1.75 (±0.05).

The refractive index of the substrate 6, i.e., the material forming the 2D or 3D grating 1a, 1b, is preferably in the range of 1.3 to 2.5, more preferably in the range of 1.4 to 2.1, more preferably still in the range of 1.45 to 1.8, and most preferably around 1.5 or 1.6. The refractive index of the substrate 6 should be higher than the refractive index of the fluid or material that the white light is travelling through to reach the grating 1a, 1b.

The height (h), periodicity (p) and refractive index may vary depending on the medium which is adjacent the grating 1a, 1b that the light is incident through, for example, whether it is air, water or some other fluid. The height and periodicity of the protuberances 2 will also vary depending on the refractive index of the substrate 6.

In further embodiments, in the complete security device there may be a portion of 2D grating 1a and a portion of 3D grating 1b. Preferably the different portions of 2D and 3D grating 1a, 1b are arranged in a pattern, for example, to add tonal contrast to the security image or to provide complimentary security images when viewed at different angles or in different locations of the security device. In a further embodiment the security image is generated by a plurality of 2D grating portions 1a (which may be of the same or different profile) and/or a plurality of 3D grating portions 1b (which also may be of the same or different profile).

For example, in one preferred embodiment, the grating 1a could be provided in quarters of a square or rectangle, with the periodicity of the protuberances/grooves being equal in opposite corners and different in adjacent corners. The grating 1a may then generate a security image from a narrowband reflection of violet light from two opposite corners and a narrowband reflection of green/turquoise light from the other two corners.

The grating 1a, 1b is preferably a planar structure. However some amount of curvature may be tolerated and in some cases may even add to the optical effect that can be produced.

The gratings 1a, 1b also need not be surface structures but instead could be internal structures. Thus transparent material, with suitably chosen refractive indexes, may be provided either side of the 2D or 3D gratings.

As mentioned above, the profile of the grooves/protuberances 2 may vary from that shown in FIGS. 1 and 2 (e.g., the ridges of the 2D grating may have a saw-tooth profile). However, preferably at least 50%, more preferably at least 75% and most preferably more than 90% of the grating 1a, 1b of the security device reduces reflected visible wavelengths (400-700 nm) by a factor of at least five when the visible light is incident at an angle normal to the grating 1a, 1b. More preferably it reduces reflected visible wavelengths by a factor of at least eight, and still more preferably by a factor of at least ten. Preferably this reduction in reflected visible wavelengths is for observation angles of up to 45° from the surface normal.

Alternatively, where the focus lies with the refracted and internally reflected violet light and not the antireflection, the 2D or 3D grating could be produced internally, within a transparent material, using laser etching or stepwise etching and deposition techniques. Here, the violet reflection at glancing angles can still be captured via total internal reflection. This could be made within the material of an object or as an adhesive film which can be attached to an article. This internal arrangement carries the advantage of resistance against abrasion and rubbing.

The overall dimensions of the grating 1a, 1b should be of a size that makes the security image visible, for example, greater than 2 μm, at least in the length (x) and width (y) dimensions. The thickness of the substrate for the grating 1a, 1b is preferably also greater than 2 μm in the thickness dimension (z). More preferably the length and width dimensions exceed 1 mm and most preferably are 5 mm or more, for example, 1-2 cm, though could of course be larger. More preferably the thickness dimension exceeds 200 μm, and most preferably it is 500 μm or greater.

The greater the number of grooves in the grating (i.e. the larger the area of grating), the more intense or brighter the violet/green/turquoise light appears. This is because although only a few grooves comprise an individual reflector, incident white light will always (unless a controlled laser) have a degree of angular spread, thus providing a range of angles of incidence and illuminating multiple reflectors within the grating, whose reflections combine within the eye.

FIG. 3a illustrates the way white light which is incident on the grating 1a, 1b can be retro-reflected and refracted by the protuberances 2. Additional reflections may also be present at grazing angles of incidence.

White light (W) which is incident along the grating or surface normal (N) will pass straight through. When the white light is incident off the surface normal at an angle of up to 45° or more, e.g., up to 65° or so, a proportion of the light will pass through the grating to enter the material, its path deviating closer to the normal through refraction as a result of travelling through the substrate material 6 which has a higher refractive index than the air or other surrounding medium on the incidence side of the grating 1a, 1b. As the white light becomes incident at a shallower angle to the structure's surface, e.g., at an angle of say, up to 25° from the surface of the antireflective structure (65° from the surface normal), ultraviolet light (UV-A) will start to be retro-reflected at a glancing angle (say, up to 12.5° from the surface of the antireflective structure). As the security device is illuminated at a shallower angle still, a narrowband reflection of violet light will start to be retro-reflected from the surface and possibly a green or turquoise narrowband reflection after that. The remainder of the white light may be split into the component colours of blue (B), green (G), yellow (Y), orange (O), and red (R) on the other side of the normal, and refracted towards the grating normal as shown.

FIG. 3b illustrates the effect on white light when a grating 1a, 1b is provided on a transparent substrate 6 that can also act as a waveguide. As shown the white light is split into its component colours according to wavelength, with a red component (R) following a path closest to the surface normal (N), a yellow (Y) component next, a green (G) component after that and a blue component (B) following a path further from the surface normal. A narrowband violet (V) retro-reflection is refracted within the material at a much shallower glancing angle, where it is then captured and guided by the transparent layer 6 as a result of total internal reflection, until it reaches the edge 7 of the transparent layer 6. A retro-reflected ultraviolet component (UV-A) may also be present at a glancing angle above the grating 1a, 1b as shown.

FIGS. 4a to 4d illustrate the effect of white light incident from different angles of incidence on a working example of a preferred grating 1a for a security device.

In this example, white light was produced by a light emitting diode with a relatively narrow angular spread and directed on to the grating 1a. The grating 1a was attached to a clear, transparent perspex substrate which had roughened edges to enhance the appearance of the edge colouration. The grating 1a comprised a sinusoidal profile having a periodicity (p) of 205 nm and a height (h) of the grooves/protuberances 2 of about 115 nm. The refractive index of the grating material was around 1.5. It was adhered to the perspex substrate using index-matched adhesive, the perspex substrate also having a refractive index of around 1.5.

FIGS. 4a and 4b illustrate the edge colouration of the substrate. When the white light (W) is incident at angles within ±45° about the grating normal (N), no colours are visible at the edge 7 of the substrate 6. However at an angle of incidence of about ±45° to the surface normal a narrowband reflection of violet light (V) begins to appear at the edge 7. As the angle of incidence becomes shallower (i.e., closer to the sinusoidal surface of the grating 1a and further from the surface normal) and the incident light reaches grazing angles, then the narrowband violet reflection visible at the edge 7 of the substrate 6 is replaced for a turquoise one (T). No other colours are observed at the edge 7. UV light will be reflected from the grating 1a when the white light is incident within about ±50° of the grating normal.

FIGS. 4c and 4d illustrate when the corresponding surface reflections are observed for the grating 1a. When the white light is incident on the grating 1a within around ±65° of the grating normal (N) (25° to the surface plane), a narrowband violet (V) reflection starts to be seen above the grating 1b. It remains as an observable violet reflection as the incident white light reaches grazing angles. No other colours are observed. UV light will be reflected when white light is incident within around ±60° of the grating normal.

The creation of the narrowband reflections of violet, turquoise and ultraviolet light at glancing angles will depend to some extent on the characteristics of the grating 1a, 1b and substrate 6 and in particular its refractive index and critical angle in the case of FIG. 3b. A range of 22.5°, more preferably 15°, still more preferably 12.5° and more preferably still 10°, from the surface of the substrate (above and below the grating) is likely to encompass the majority of glancing angles exhibited by the narrowband reflection.

The security image can be generated at an edge 7 of the transparent layer 6 as shown in FIG. 3b or it may be guided to some other viewable location using further light guide devices. A lens or other shape applied to cause the violet light to spread to desirable directions. For example, a rounded lens (refractive-index matched) could be applied to the surface of the article to act as an exit point for the violet light. The violet (or green/turquoise) light of the security image in FIG. 3b ideally should be viewable by an observer without the need for specialist equipment.

Interestingly, the light that emerges from the edge 7 can be observed from any angle and/or direction. The edge 7 of the substrate 6 appears as an illuminated strip, probably due to surface roughness creating a scattering effect.

The security image may further be refined by modifying the violet illumination produced by the grating 1a, 1b, e.g., by adapting areas of the grating 1a,1b to reflect more or less violet (or green/turquoise) light to a given location on the security device, and in that way create a pattern (e.g., representing a code, character, symbol or mark) that can be easily recognised by an observer. Areas, for example, strips of the grating 1a, 1b could be covered over to create areas of dark and light in the security image, e.g., as in a barcode. Black ink could be used to cover over such areas. Regions of dark and light may also be generated in the security image by providing optical obstacles in the transparent layer that reduce or remove the amount of violet light reaching the edge and forming the security image, e.g., by creating a shadow to contrast with violet light that is able to travel straight through unaffected.

In the arrangement of FIG. 3b, depending on the angle of the incident illumination a narrowband reflection of ultraviolet light may also be retro-reflected from the surface of the antireflective structure at a glancing angle. This too can be observed, for example, using a ultraviolet reader, to establish authentication of the article. This reflected ultraviolet light may also be modified to provide regions of dark and light in the security image, e.g., to create a barcode or similar.

A finer spaced grating (smaller periodicity) will result in UV replacing violet in these arrangements. Indeed, a grating can be optimized to reflect UV only (which can be read by a detector), acting as an antireflector for all visible wavelengths.

FIG. 5 shows a perspective view of a preferred embodiment of an article 8 provided with a preferred security device 10. The illustrated article 8 is a credit card, though it could be a debit card, store card, phone card, identity card, permit card, a gambling chip or indeed any other type of laminated article provided with such a security device 10.

The article 8 comprises a transparent layer of material which provides a substrate 6 for a grating 1a, 1b. The substrate 6 is sandwiched between two opaque layers 11, 12 arranged on opposite sides of the substrate 6. FIG. 6 illustrates a perspective view of the middle layer for the security device in FIG. 5 (i.e. with the upper and lower layers 11, 12 removed). In one of the opaque layers 11 (the top layer) there is provided a window 13 that allows white light, for example, sunlight, to enter the transparent layer 6. The window 13 could comprise any shape and need not be rectangular as shown in the figure. For example, the window 13 could have an outline shape corresponding to an attractive object, such as a diamond or cut crystal. The grating 1a, 1b is provided on an area of the substrate 6 that is exposed by the window 13. The outline of the grating 1a, 1b may correspond exactly to the perimeter of the window or it may be different, for example, it may comprise stripes or a pattern, or it may comprise a smaller mark or symbol arranged spaced in from the perimeter of the window 13.

Recessing the grating 1a, 1b within the window 13 helps to protect the grating 1a, 1b from becoming damaged. A protective layer of significantly lower refractive index could also be provided over the grating 1a, 1b.

The security device 10 could be applied to one side of the article 8 (as illustrated) or to both sides, opposite each other, to provide a transparent window 13 in the article 8 with the security device 10 on both surfaces.

White light (e.g., sunlight) which is incident on the grating 1a, 1b through the window 13 enters the transparent material of the substrate 6 and is refracted by the material because of the higher refractive index, as described in FIG. 3b. The white light is also split into its component parts, with a narrowband violet reflection being refracted at a glancing angle to the surface of the transparent substrate 6. This violet component is captured by the substrate 6 and then guided along the layer of transparent material 6 as a result of total internal reflection. This occurs because the angle of incidence each time the light meets a surface of the substrate 6 is less than the critical angle for the substrate 6. The violet reflection continues until it reaches a surface where the angle of incidence is sufficiently large that the violet light is transmitted from the substrate 6 (i.e., it meets a surface at an angle of incidence greater than the critical angle), for example, where the light meets an edge of the substrate 6.

Where the narrowband reflection is transmitted from the substrate 6 a violet security image will be created. In FIGS. 3b and 5 the security image is created at an edge 7 of the layer of transparent material that forms the substrate 6.

The shape of the security image will be defined by the extremities of the window 13 and where the grating 1a, 1b has been applied to the substrate 6. In the embodiment illustrated in FIG. 5 a simple security image 14 comprising a band of violet light is shown by the shading. Thus only the shaded region 14 in FIG. 5 appears violet, and the violet colour comes and goes as the card 8 is tilted, unlike an illuminated violet-dyed central layer.

If sunlight is incident from the opposite direction, then the directions of the reflections will be reversed. If the security device 10 comprises a 3D grating then it will have the ability to reflect in any direction, substantially equal to that of the incident light. If a 2D grating 1a is employed then it will only reflect when the incident light is along the plane that is perpendicular to the grooves (i.e. from two broad directions over a 360° rotation for a conical or sinusoidal 2D grating 1a, or from one broad direction over a 360° rotation for a saw-tooth 2D grating).

It would, of course, be possible to create a more elaborate security image 14 through modifying the shape of the window 13 and the shape of the region where the antireflective structure la, 1b is applied. The window 13 can also be placed anywhere on the card or article 8.

In the embodiment illustrated in FIG. 5, the security device 10 comprises a 2D grating 1a so that one edge 7 is illuminated when white light is incident on the window 13 and one is left dark. If a 3D grating 1b is used, then the violet light can be made to emerge from all of the edges 7 of the device rather than only two.

The security image 14 can also be made more complicated through choosing a combination of different 2D gratings, which are different in their periodicity and orientation (in which case different colours will emerge from different edges as the object is rotated while viewed edge-on).

Other light guides or optical devices may also be employed to create a security image 14 with other optical effects or at other locations, for example, in a window 13 on the front or rear of the credit card 8 which is lit by the violet reflection.

In addition to the violet lit security image 14, the window 13 will also appear distinctive due to its lack of surface sheen, and therefore this will, to an extent, provide an anti-counterfeiting function too.

When white light is incident on the window as shown in FIG. 5, retro-reflected from the antireflective grating 1a, 1b will be an ultraviolet reflection (e.g., UV-A) at a glancing angle above the surface of the substrate 6. This UV-A reflection can also be used, for example, through reading by a detector to provide authentication too.

It is also possible to alter the periodicity of the protuberances 2 or refractive index of the substrate 6 in order to reflect not only the UV-A reflection but also the violet light above the surface of the substrate 6.

The layers of the security device 10 may be formed from conventional plastics materials. The grating 1a, 1b may be provided as a coating (e.g., deposited, adhered, printed, etc.) or it may be formed in the material of the substrate 6 (e.g., moulded, stamped, etched, embossed, etc.). If it is attached to the substrate then the antireflective coating and any adhesive should be refractive-index matched. In one example, the security device 10 is made by depositing dedicated transparent plastic sheets with sticky backs. The plastic and the glue is refractive index-matched with the substrate material 6 it is bonded to.

An embodiment is also envisaged where one or both of the opaque layers 11, 12 in FIG. 5 is/are omitted (for example, an embodiment similar to FIG. 6). A violet light security image 14 is generated at the edge 7 of the substrate 6 in a similar way to the embodiment of FIG. 5. A UV-A reflection may also be present at glancing angles. A transparent cover of significantly different refractive index may be provided over at least the grating 1a, 1b of the security device 10 to protect the sub-micron profiled structure. The grating 1a, 1b may instead be recessed to provide the desired degree of protection.

The security device 10 has application for precious objects like crystal figures, jewelry, glass bottles and the credit/identity cards mentioned above to provide an anti-counterfeiting operation. It also may have benefits on items such as watch glasses and solar panels, since these would also benefit from the antireflection properties. For solar panel glass, the narrowband violet/green/turquoise reflection 14 would indicate a degree of quality of antireflection (the primary function), in the manner of a kite mark, since the antireflection property, desirable for solar panel surfaces, is difficult to assess by eye.

In another embodiment, the substrate 6 may comprise an opaque material or a transparent material. Instead of using the violet (or green/turquoise) light refracted and reflected within the substrate, however, this security device relies on the violet, green, turquoise or ultraviolet light narrowband reflection that is reflected at a glancing angle above the grating to generate the security image for the observer.

For example, in the embodiment of FIG. 7a a 2D grating 1b is provided having an outline shape approximately corresponding to the shape of the security image 14 that it is desired to be seen; the outline shape of the grating 1b is elongated in a dimension perpendicular to the longitudinal direction of the ridges. Thus in the illustration, the shape of the grating 1b has a swan-like appearance when viewed along the surface normal. However, when the narrowband violet or green/turquoise retro-reflection produced by the grating 1b is viewed at its glancing angle, a violet or green/turquoise security image 14 as seen in FIG. 7b is generated in the eye of the observer. The foreshortening of the shape reduces the swan-like outline of the grating 1b to a duck-like outline of violet or green/turquoise light when the security device 10 is illuminated by white (sun) light incident perpendicular to the grooves of the grating 1b. No other colours emerge from the surface of the substrate 6. The security image 14 generally only appears when viewed in retro-reflection; otherwise it is not visible.

In one embodiment such a security device 10 is etched into crystal to provide a mark of authentication. The security device 10 would be relatively unobtrusive and visible only due to the comparative lack of sheen at normal angles of viewing. However at glancing angles, the violet security image 14 would then be visible to an observer.

The 2D grating 1a could be applied in an inset 15 to a base of, for example, a figurine or to jewelry as shown in FIG. 8 for protection from rubbing.

FIG. 9a illustrates a watch glass 20 on which is embossed a 2D grating 1a to an inner surface. The grating 1a provides an anti-counterfeiting function and will also help to reduce glare, providing better visibility of the watch face from most angles of view. This could be combined with a “structural black” watch face below it, for example, a structural black comprising a hexagonal or other light retaining structure as described in WO-A-2011/161482. In such structural black coatings, wall-like elements are provided normal to the substrate surface having dimensions of around 1 μm or less, e.g., 1000 nm (l)×150 nm (w)×1000 nm (h) which are arranged in a pattern to prevent reflections of visible light from leaving the substrate, causing the substrate to appear black.

FIG. 9b illustrates a side view of the watch glass 20 illustrating a violet colour 21 that would be visible from glancing angles or from viewing the watch side on. As in the previous embodiments, the properties of the grating 1a, 1b can be varied in order to modify the security image 14 that is produced. For example, if a 2D grating 1b is used, the violet colour 21 would emerge only when viewed in retro-reflection (i.e. as the watch is rotated and viewed edge-on; with the light source fixed, the violet light 21 would appear and disappear with every 180 degree rotation).

FIG. 10 illustrates a further embodiment where a watch face 30 is provided with an antireflective grating 1a,1b. The watch face 30 comprises a material which has been filled with a dark pigment for the majority of its surface. In selected areas, gaps are provided in the dark pigment. The watch face 30 is embossed with a grating 1a, 1b, preferably a 3D grating 1b. The main part of the watch face appears very matte because of the grating 1a, 1b. The dark pigment absorbs the red through to blue colour components of the incident white light. The periodicity of the protuberances 2 is chosen so that violet light becomes visible at glancing angles of view. In the gaps, a bright colour can be observed for maximum contrast.

Alternatively, ultraviolet light only could be reflected, which although not visible to the eye, could become visible if directed onto appropriate fluorescent paints (i.e. the paints would “glow” brighter). Here, if phosphorescent paint is used instead of fluorescent paint, the paint would “glow-in-the-dark” for longer, since it will have absorbed more energy from UV light (which is later re-emitted as visible light).

In accordance with the previous embodiments, the grating 1a, 1b may be embossed or stamped into the surface of a watch or other material, or it can be attached to the substrate 6, e.g., using refractive index matched adhesive.

The security device may be applied to a range of articles as indicated above. Other applications include car head lamps or other forms of luminaire where the security image can indicate that the source of origin or that it meets certain standards. The security device could be incorporated into glazing products, e.g., for vehicles or buildings, sunglasses, bottles, screens, etc. It could also be applied to articles such as personal electronic devices, e.g., smart phones and notepads, etc. The security device could also be used as a security covering for signs or labels that need to be read clearly at normal incidence or within a 45 degree cone or range, such as car number plates, medical labels, passport photos etc.

1. A security device comprising a substrate having a region provided with an antireflective grating, the security device being configured to generate a security image when visible light is incident on the grating to provide authentication for an observer, wherein the grating comprises a combined broadband antireflective and narrowband reflective structure, the structure being antireflective for visible light between 400 and 700 nm which is incident within ±45° of a normal to the grating and the structure producing a narrowband reflection of light having a wavelength of less than 550 nm at glancing angles to the grating when visible light is incident at an angle greater than ±45° from the grating normal, wherein the security device is configured to generate the security image from the narrowband reflection.

2. A security device as claimed in claim 1, wherein the security device is arranged to generate the security image from visible light that is reflected within the substrate at a glancing angle to the grating when the visible light is incident at an angle greater than ±45° from the grating normal, the narrowband reflection having a direction that is shallower than a critical angle for the light in the substrate, whereby it is guided along the substrate by total internal reflection.

3. A security device as claimed in claim 2, wherein the narrowband reflection is transmitted from a region of the substrate spaced from the grating, preferably from an edge.

4. A security device as claimed in claim 1, wherein the security device includes opaque layers provided on opposite sides of the substrate, at least one of the opaque layers including a window in which the antireflective grating is provided.

5. A security device as claimed in claim 1, wherein the antireflective structure comprises a two dimensional array of sub-micron sized features.

6. A security device as claimed in claim 1, wherein the antireflective structure comprises a three dimensional array of sub-micron sized features.

7. A security device as claimed in claim 1, wherein the security device is arranged to generate the security image from a narrowband reflection that is retro-reflected from a surface of the grating at a glancing angle to the grating on an incident side of the grating.

8. A security device as claimed in claim 7, wherein the antireflective grating comprises a two dimensional array of sub-micron sized features defining a plurality of parallel grooves and protuberances, the antireflective grating having an outline shape which has been extended in a direction normal to the grooves to compensate for foreshortening in the observed security image.

9. A security device as claimed in claim 1, wherein the narrowband reflection which generates the security image is a violet reflection.

10. A security device as claimed in claim 1, wherein the narrowband reflection which generates the security image is a green reflection.

11. A security device as claimed in claim 1, wherein the narrowband reflection which generates the security image is a turquoise reflection.

12. A security device as claimed in claim 1, wherein the narrowband reflection which generates the security image is an ultraviolet-A reflection.

13. A security device as claimed in claim 1 wherein the security image comprises a narrowband retro-reflection from the incident side of the antireflective grating of a first colour and a narrowband retro-reflection from the substrate side of the antireflective grating of a second colour different to the first colour.

14. A security device as claimed in claim 13, wherein the first colour is violet and the second colour is green or turquoise.

15. A security device as claimed in claim 1, wherein optical elements are provided in the path of the narrowband reflection to modify the security image generated by the reflection.

16. An article comprising a security device as claimed claim 1.

17. An article as claimed in claim 16 comprising a laminated card, wherein the security device is integral with the article.

18. An article as claimed in claim 16, wherein the security device has been formed in or attached to a surface of the article.

19. An article as claimed in claim 18, wherein the article is a watch glass.

20. An article as claimed in claim 18, wherein the article is an ornament or gemstone.
